(19) United States
(12) Patent Application Publication
(10) Pub. No.: US 2025/0123641 A1
(43) Pub. Date: Apr. 17, 2025

(54) TEMPERATURE CONTROL METHOD AND TEMPERATURE CONTROL SYSTEM

(71) Applicant: Hefei Core Storage Electronic Limited, Anhui (CN)

(72) Inventors: Chih-Ling Wang, Anhui (CN); Qi-Ao Zhu, Anhui (CN); Dong Sheng Rao, Anhui (CN)

(73) Assignee: Hefei Core Storage Electronic Limited, Anhui (CN)

(21) Appl. No.: 18/504,163

(22) Filed: Nov. 8, 2023

(30) Foreign Application Priority Data
Oct. 12, 2023 (CN) 202311324573.5

(51) Int. Cl. G05D 23/24; G01K 7/22

(52) U.S. Cl. CPC G05D 23/24; G01K 7/22

(57) ABSTRACT

A temperature control method and a temperature control system for controlling a temperature of a target device are disclosed. The target device is disposed in a temperature control device. The method includes: controlling an internal temperature of the temperature control device according to a base parameter and a compensation parameter; detecting a temperature of the target device via a temperature sensor during the period that the internal temperature of the temperature control device is controlled according to the base parameter and the compensation parameter; and adjusting the compensation parameter according to the temperature of the target device to change the internal temperature of the temperature control device.

### CROSS-REFERENCE TO RELATED APPLICATION

This application claims the priority benefit of China application serial no. 202311324573.5, filed on Oct. 12, 2023. The entirety of the above-mentioned patent application is hereby incorporated by reference herein and made a part of this specification.

### BACKGROUND OF THE INVENTION

### Field of the Invention

The invention relates to a temperature control method and a temperature control system.

### Description of Related Art

Before an electronic device leaves the factory, it is often necessary to conduct a stability test on the electronic device under different temperature conditions. For example, common testing methods include placing the electronic device in a constant temperature and humidity testing machine, and monitoring the operating stability of the electronic device under different test conditions by changing the internal temperature of the constant temperature and humidity testing machine. However, even if the electronic device is placed in the constant temperature and humidity testing machine, the actual temperature of the electronic device may still be different from the internal temperature of the constant temperature and humidity testing machine, thereby reducing test accuracy.

### SUMMARY OF THE INVENTION

The invention provides a temperature control method and a temperature control system that may improve the temperature control efficiency of a target device in a temperature control device.

An exemplary embodiment of the invention provides a temperature control method for controlling a temperature of a target device. The target device is disposed in a temperature control device. The temperature control method includes: controlling an internal temperature of the temperature control device according to a base parameter and a compensation parameter; detecting a temperature of the target device via a temperature sensor during the period that the internal temperature of the temperature control device is controlled according to the base parameter and the compensation parameter; and adjusting the compensation parameter according to the temperature of the target device to change the internal temperature of the temperature control device.

An exemplary embodiment of the invention further provides a temperature control system including a temperature control device and a controller. The controller is coupled to the temperature control device. The target device is disposed in the temperature control device. The controller is configured to: control an internal temperature of the temperature control device according to a base parameter and a compensation parameter; detect a temperature of the target device via a temperature sensor during the period that the internal temperature of the temperature control device is controlled according to the base parameter and the compensation parameter; and adjust the compensation parameter according to the temperature of the target device to change the internal temperature of the temperature control device.

Based on the above, after the target device is disposed in the temperature control device, the internal temperature of the temperature control device may be controlled according to the base parameter and the compensation parameter. During the period of controlling the internal temperature of the temperature control device according to the base parameter and the compensation parameter, the temperature of the target device may be detected via the temperature sensor, and the compensation parameter may be adjusted according to the temperature of the target device. Thereby, the temperature control efficiency of the target device in the temperature control device may be effectively improved.

### BRIEF DESCRIPTION OF THE DRAWINGS

FIG. 1 is a schematic diagram of a temperature control system shown according to an exemplary embodiment of the invention.

FIG. 2 is a schematic diagram of changes in the temperature of a target device and the internal temperature of a temperature control device at different time points shown according to an exemplary embodiment of the invention.

FIG. 3 is a schematic diagram of a data table recording compensation parameters shown according to an exemplary embodiment of the invention.

FIG. 4 is a schematic diagram of a temperature control device and an electronic device disposed inside the temperature control device shown according to an exemplary embodiment of the invention.

FIG. 5 is a flowchart of a temperature control method shown according to an exemplary embodiment of the invention.

### DESCRIPTION OF THE EMBODIMENTS

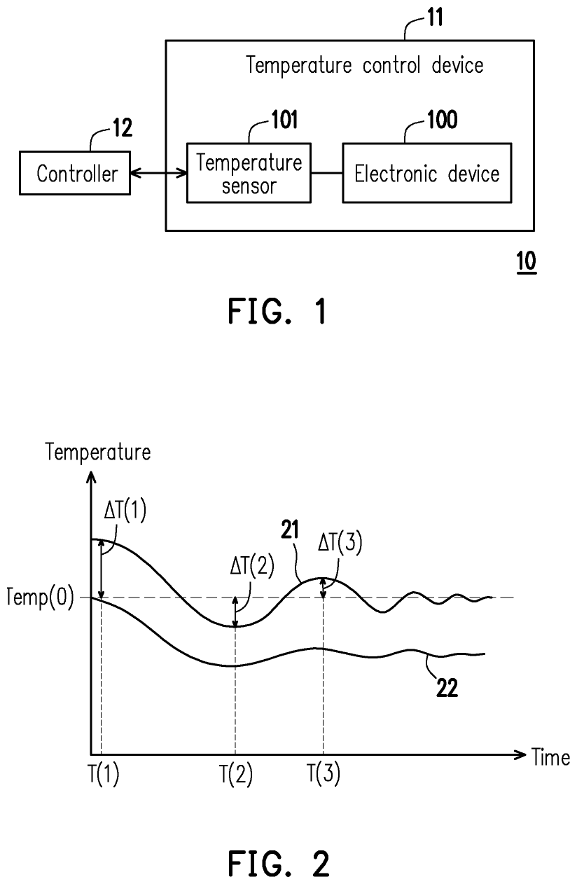

FIG. 1 is a schematic diagram of a temperature control system shown according to an exemplary embodiment of the invention. Please refer to FIG. 1, a temperature control system 10 includes a temperature control device 11 and a controller 12. The temperature control device 11 may be configured to accommodate an electronic device (also called a target device or a device under test) 100. The total number of the electronic device 100 may be one or a plurality, and the invention is not limited thereto. After the electronic device 100 is disposed in the temperature control device 11, the temperature control device 11 may be configured to control the temperature of the electronic device 100. For example, the temperature control device 11 may attempt to control the temperature of the electronic device 100 to be close to or equal to a specific temperature (also referred to as a target temperature).

In an exemplary embodiment, the temperature control device 11 may control (including change) the internal temperature of the temperature control device 11 via an air conditioning equipment (not shown), thereby affecting the temperature of the electronic device 100 disposed inside the temperature control device 11. In an exemplary embodiment, the temperature control device 11 may control the internal temperature of the temperature control device 11 via other types of temperature control equipment, which is not limited by the invention.

The controller 12 is coupled to the temperature control device 11. The controller 12 may be configured to control the internal temperature of the temperature control device 11. For example, the controller 12 may include a central processing unit (CPU), or other programmable general-purpose or special-purpose microprocessors, digital signal processors (DSPs), programmable controllers, application-specific integrated circuits (ASICs), programmable logic devices (PLDs), or other similar devices, or a combination of the devices.

In an exemplary embodiment, the electronic device 100 is a memory storage device. For example, the electronic device 100 may include a rewritable non-volatile memory module and a memory controller configured to control the rewritable non-volatile memory module. In an exemplary embodiment, the electronic device 100 may also be other types of electronic devices, which is not limited by the invention.

In an exemplary embodiment, the controller 12 may execute a test program on the electronic device 100 disposed in the temperature control device 11. This test program may be configured to test the operating stability of the electronic device 100 under specific test conditions (such as high or low temperature environments). Taking a memory storage device as an example, the test program may be configured to test the operating stability of the electronic device 100 when performing a data reading operation and/or a data writing operation under specific test conditions (such as high or low temperature environments). In an exemplary embodiment, the specific test conditions may include maintaining the temperature of the electronic device 100 at a target temperature.

In an exemplary embodiment, the controller 12 may control the internal temperature of the temperature control device 11 according to one base parameter and one compensation parameter. The base parameter corresponds to the target temperature. The compensation parameter may be configured to compensate the base parameter. For example, the controller 12 may transmit at least one of the base parameter and the compensation parameter to the temperature control device 11 to control (including change) the internal temperature of the temperature control device 11.

In an exemplary embodiment, after the target temperature is determined, the controller 12 may set the base parameter according to the target temperature. Without considering the compensation parameter, the controller 12 may control the internal temperature of the temperature control device 11 to be (substantially) the same as the target temperature according to the base parameter. However, if the internal temperature of the temperature control device 11 is controlled solely according to the base parameter, the temperature of the electronic device 100 may not reach (or approach) the target temperature at all or within a short period of time.

In an exemplary embodiment, the controller 12 may compensate the base parameter according to the compensation parameter to change the internal temperature of the temperature control device 11. In particular, by actively adjusting the internal temperature of the temperature control device 11, the temperature of the electronic device 100 may be accelerated to converge to the target temperature.

In an exemplary embodiment, during the period of controlling the internal temperature of the temperature control device 11 according to the base parameter and the compensation parameter, the controller 12 may detect the temperature of the electronic device 100 via the temperature sensor 101. For example, the temperature sensor 101 may include a thermistor or other sensors that may be configured to monitor the temperature of the electronic device 100.

In an exemplary embodiment, the temperature sensor 101 may be in physical contact with the electronic device 100. For example, the temperature sensor 101 may be disposed in the electronic device 100 or attached to the surface of the electronic device 100. In an exemplary embodiment, the temperature sensor 101 may also not be in physical contact with the electronic device 100. For example, the temperature sensor 101 may detect the temperature of the electronic device 100 without contact by sending and receiving an infrared signal.

In an exemplary embodiment, the controller 12 may send a command (also called a temperature query command) to the electronic device 100 via a connection interface (not shown). This temperature query command may be configured to query the temperature of the electronic device 100. The electronic device 100 may receive the temperature query command and generate a response to the temperature query command. For example, in response to the temperature query command, the electronic device 100 may include temperature information in the response. This temperature information may reflect the temperature of the electronic device 100 at a specific point in time. Then, the controller 12 may receive the response and obtain the temperature of the electronic device 100 according to the response.

In an exemplary embodiment, the controller 12 may also send another command (also called a test command) via the connection interface. This test command may be configured to instruct the electronic device 100 to perform a specific operation during the stability test. Taking a memory storage device as an example, the test command may instruct the electronic device 100 to perform a read operation, a write operation, and/or an erase operation on the internal rewritable non-volatile memory module. Moreover, if the electronic device 100 is another type of device, the test command may be configured to instruct the electronic device 100 to perform other types of operations during the stability test, which is not limited by the invention.

In an exemplary embodiment, after the temperature of the electronic device 100 is obtained, the controller 12 may dynamically adjust the compensation parameter according to the temperature of the electronic device 100. By adjusting the compensation parameter, the internal temperature of the temperature control device 11 may be changed accordingly (e.g., increased or decreased). For example, by adjusting the compensation parameter, the internal temperature of the temperature control device 11 may be increased by P degrees or reduced by Q degrees.

In an exemplary embodiment, during the period of controlling the internal temperature of the temperature control device 11 according to the base parameter and the compensation parameter, the controller 12 may obtain the difference between the temperature of the electronic device 100 and the target temperature. The controller 12 may dynamically determine the compensation parameter according to the difference.

In an exemplary embodiment, in response to the difference between the temperature of the electronic device 100 and the target temperature being a specific value (also referred to as a first difference), the controller 12 may set the compensation parameter to a specific parameter (also referred to as a first compensation parameter). Moreover, in an exemplary embodiment, in response to the difference between the temperature of the electronic device 100 and the target temperature being another value (also referred to as a second difference), the controller 12 may set the compensation parameter to another parameter (also referred to as a second compensation parameter). The first difference is different from the second difference. The first compensation parameter is different from the second compensation parameter.

FIG. 2 is a schematic diagram of changes in the temperature of a target device and the internal temperature of a temperature control device at different time points shown according to an exemplary embodiment of the invention. Please refer to FIG. 1 and FIG. 2, it is assumed that a curve 21 is configured to represent the temperature of the electronic device 100 (i.e., the target device) at different time points, and a curve 22 is configured to represent the internal temperature of the temperature control device 11 at different time points. In addition, it is assumed that a temperature Temp(0) is the target temperature.

In an exemplary embodiment, the controller 12 may determine the base parameter according to the temperature Temp(0). For example, controller 12 may input the temperature Temp(0) into an algorithm or a data table. The controller 12 may determine the base parameter according to the output of the algorithm or the data table. Then, the controller 12 may control the internal temperature of the temperature control device 11 according to the base parameter. For example, the controller 12 may maintain the internal temperature of the temperature control device 11 at the target temperature according to the base parameter. However, if the internal temperature of the temperature control device 11 is controlled simply according to the base parameter, the temperature of the electronic device 100 may not reach (or approach) the target temperature at all or within a short period of time due to various factors (for example, the amount of heat generated by the electronic device 100 per unit time is too high).

In an exemplary embodiment, the controller 12 may dynamically adjust the internal temperature of the temperature control device 11 (represented by the curve 22) according to the temperature of the electronic device 100 (represented by the curve 21). For example, the controller 12 may dynamically adjust the internal temperature of the temperature control device 11 according to the difference between the temperature of the electronic device 100 and the temperature Temp(0) at one or a plurality of time points.

In an exemplary embodiment, the controller 12 may dynamically determine (including adjust) the compensation parameter according to the temperature of the electronic device 100 at one or a plurality of time points. For example, the controller 12 may obtain a difference ΔT(i) corresponding to a time point T(i). The difference ΔT(i) may reflect the difference between the temperature of the electronic device 100 and the temperature Temp(0) at the time point T(i). The controller 12 may determine (including adjust) the compensation parameter according to the difference ΔT(i). For example, the controller 12 may input the difference ΔT(i) into an algorithm or a data table. The controller 12 may determine the compensation parameter according to the output of the algorithm or the data table. Then, the controller 12 may control (including adjust) the internal temperature of the temperature control device 11 according to the compensation parameter.

Taking FIG. 2 as an example, in an exemplary embodiment, the controller 12 may obtain differences ΔT(1), ΔT(2), and ΔT(3) corresponding to time points T(1), T(2), and T(3) respectively. The difference ΔT(1) may reflect the difference between the temperature of the electronic device 100 and the temperature Temp(0) at the time point T(1). The difference ΔT(2) may reflect the difference between the temperature of the electronic device 100 and the temperature Temp(0) at the time point T(2). The difference ΔT(3) may reflect the difference between the temperature of the electronic device 100 and the temperature Temp(0) at the time point T(3). The controller 12 may adjust the internal temperature of the temperature control device 11 at different time points according to the differences ΔT(1), ΔT(2), and ΔT(3). For example, the adjusted internal temperature of the temperature control device 11 is shown in the curve 22.

In an exemplary embodiment, by dynamically adjusting the internal temperature of the temperature control device 11, the temperature of the electronic device 100 may be accelerated to converge to the temperature Temp(0) (as indicated by the end of the curve 21). It should be noted that the curve 21 and the curve 22 in FIG. 2 are only examples and are not intended to limit the invention.

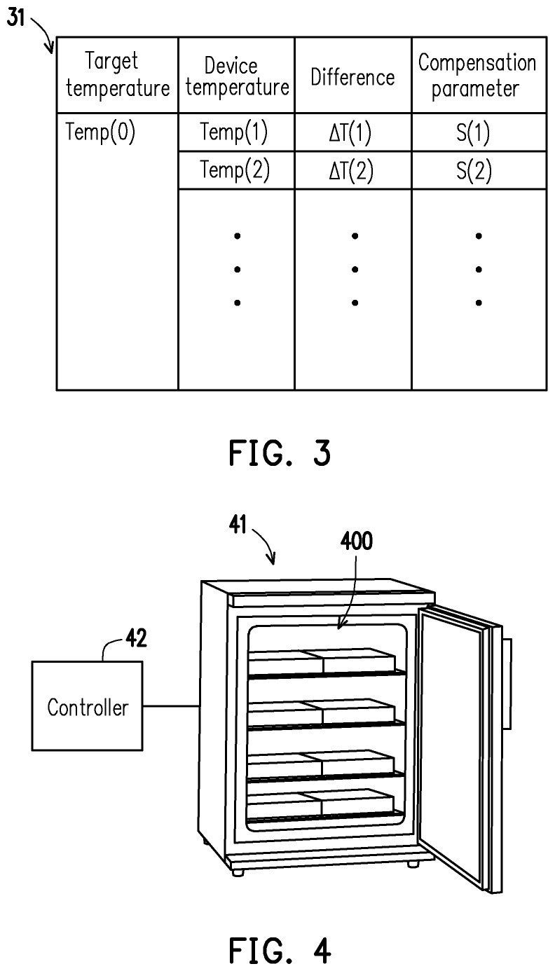

FIG. 3 is a schematic diagram of a data table recording compensation parameters shown according to an exemplary embodiment of the invention. Please refer to FIG. 1 and FIG. 3, in an exemplary embodiment, the controller 12 may create or load the data table 31. The data table 31 may recite the association (or mapping relationship) between the temperature of the electronic device 100 (i.e., a Temp(i), and i is greater than zero) (and/or the difference ΔT(i)) and a compensation parameter S(i). For example, the difference ΔT(i) may reflect the difference between the target temperature (e.g., the temperature Temp(0)) and the temperature of the electronic device 100 (i.e., the Temp(i)). The controller 12 may query the data table 31 according to the temperature of the electronic device 100 (i.e., the Temp(i)) and/or the difference ΔT(i)) to obtain the compensation parameter S(i). Then, the controller 12 may adjust the internal temperature of the temperature control device 11 according to the compensation parameter S(i). It should be noted that the information recited in the data table 31 in FIG. 3 is only an example and is not intended to limit the invention. In an exemplary embodiment, the data table 31 may also be replaced by an algorithm or used in conjunction with an algorithm, which is not limited by the invention.

FIG. 4 is a schematic diagram of a temperature control device and an electronic device disposed inside the temperature control device shown according to an exemplary embodiment of the invention. Referring to FIGS. 1 and 4, in an exemplary embodiment, the temperature control device 11 includes a temperature control device 41, the controller 12 includes a controller 42, and the electronic device 100 includes an electronic device 400 (i.e., the target device). For example, the temperature control device 41 may include a temperature control box. The electronic device 400 may be mounted in the temperature control box. The controller 42 may be configured to control the internal temperature of the temperature control device 41 (e.g., a temperature control box). In addition, the controller 42 may be mounted inside or outside the temperature control device 41, which is not limited by the invention.

In an exemplary embodiment, if disposed in the temperature control device 41 (such as a temperature control box) and the number of the electronic device 400 to be tested is one, the controller 42 may adjust the internal temperature of the temperature control box according to the temperature of a single electronic device 400. Relevant operation details are described in detail above, and are not repeated herein.

In an exemplary embodiment, if disposed in the temperature control device 41 (such as a temperature control box) and the number of the electronic device 400 to be tested is a plurality (as shown in FIG. 4), the controller 42 may adjust the internal temperature of the temperature control box according to the average or the median of the temperatures of the electronic devices 400. Taking FIG. 2 as an example, if the number of the target device is greater than one, the curve 21 may be configured to represent the average or the median temperature of the target devices. Thereafter, the controller 42 may adjust the internal temperature of the temperature control box according to the difference ΔT(i). Relevant operation details are described in detail above, and are not repeated herein.

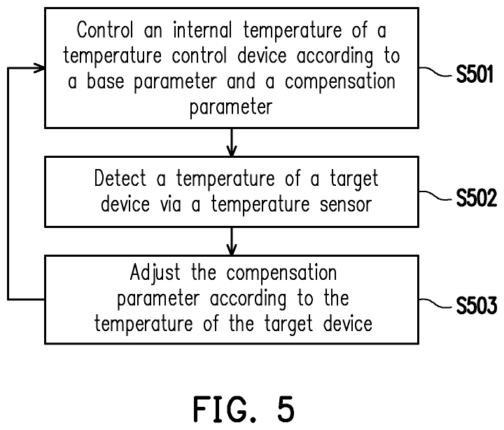

FIG. 5 is a flowchart of a temperature control method shown according to an exemplary embodiment of the invention. Referring to FIG. 5, in step S501, an internal temperature of a temperature control device is controlled according to a base parameter and a compensation parameter. In step S502, a temperature of a target device is detected via a temperature sensor during the period of controlling the internal temperature of the temperature control device according to the base parameter and the compensation parameter. In step S503, the compensation parameter is adjusted according to the temperature of the target device to change the internal temperature of the temperature control device.

However, each step in FIG. 5 is as described in detail above, and is not repeated herein. It should be mentioned that, each step in FIG. 5 may be implemented as a plurality of program codes or circuits, and the invention is not limited thereto. Moreover, the method of FIG. 5 may be used with the above exemplary embodiments, and may also be used alone, and the invention is not limited thereto.

Based on the above, the temperature control system and the temperature control method proposed by the invention may dynamically adjust the internal temperature of the temperature control device according to the actual temperature of the electronic device during the stability test of the electronic device in the temperature control device. Thereby, the temperature control efficiency of the target device in the temperature control device may be effectively improved, thus improving the accuracy of test results.

Although the invention has been described with reference to the above embodiments, it will be apparent to one of ordinary skill in the art that modifications to the described embodiments may be made without departing from the spirit of the disclosure. Accordingly, the scope of the disclosure is defined by the attached claims not by the above detailed descriptions.

What is claimed is:

1. A temperature control method, for controlling a temperature of a target device, wherein the target device is disposed in a temperature control device, and the temperature control method comprises:
controlling an internal temperature of the temperature control device according to a base parameter and a compensation parameter;
detecting a temperature of the target device via a temperature sensor during the period of controlling the internal temperature of the temperature control device according to the base parameter and the compensation parameter; and
adjusting the compensation parameter according to the temperature of the target device to change the internal temperature of the temperature control device.

2. The temperature control method of claim 1, wherein the temperature sensor comprises a thermistor.

3. The temperature control method of claim 1, wherein the temperature sensor is physically in contact with the target device.

4. The temperature control method of claim 1, wherein the temperature sensor is disposed in the target device, and the step of detecting the temperature of the target device via the temperature sensor comprises:
sending a command to the target device;
receiving a response of the target device to the command; and
obtaining the temperature of the target device according to the response.

5. The temperature control method of claim 1, wherein the compensation parameter is configured to compensate the base parameter to change the internal temperature of the temperature control device.

6. The temperature control method of claim 1, wherein the step of adjusting the compensation parameter according to the temperature of the target device comprises:
determining the compensation parameter according to a difference between the temperature of the target device and a target temperature.

7. The temperature control method of claim 6, wherein the step of determining the compensation parameter according to the difference between the temperature of the target device and the target temperature comprises:
setting the compensation parameter as a first compensation parameter in response to the difference between the temperature of the target device and the target temperature being a first difference; and
setting the compensation parameter as a second compensation parameter in response to the difference between the temperature of the target device and the target temperature being a second difference,
wherein the first difference is different from the second difference, and the first compensation parameter is different from the second compensation parameter.

8. The temperature control method of claim 1, wherein in a case that there are a plurality of the target device, the temperature of the target device is an average or a median of temperatures of the plurality of target devices.

9. The temperature control method of claim 1, wherein the target device comprises a memory storage device.

10. A temperature control system, comprising:
a temperature control device; and
a controller coupled to the temperature control device,
wherein the target device is disposed in the temperature control device, and
the controller is configured to:
control an internal temperature of the temperature control device according to a base parameter and a compensation parameter;
detect a temperature of the target device via a temperature sensor during the period of controlling the internal temperature of the temperature control device according to the base parameter and the compensation parameter; and
adjust the compensation parameter according to the temperature of the target device to change the internal temperature of the temperature control device.

11. The temperature control system of claim 10, wherein the temperature sensor comprises a thermistor.

12. The temperature control system of claim 10, wherein the temperature sensor is physically in contact with the target device.

13. The temperature control system of claim 10, wherein the temperature sensor is disposed in the target device, and the operation of the controller detecting the temperature of the target device via the temperature sensor comprises:
sending a command to the target device;
receiving a response of the target device to the command; and
obtaining the temperature of the target device according to the response.

14. The temperature control system of claim 10, wherein the compensation parameter is configured to compensate the base parameter to change the internal temperature of the temperature control device.

15. The temperature control system of claim 10, wherein the operation of the controller adjusting the compensation parameter according to the temperature of the target device comprises:
determining the compensation parameter according to a difference between the temperature of the target device and a target temperature.

16. The temperature control system of claim 15, wherein the operation of the controller determining the compensation parameter according to the difference between the temperature of the target device and the target temperature comprises:
setting the compensation parameter as a first compensation parameter in response to the difference between the temperature of the target device and the target temperature being a first difference; and
setting the compensation parameter as a second compensation parameter in response to the difference between the temperature of the target device and the target temperature being a second difference,
wherein the first difference is different from the second difference, and the first compensation parameter is different from the second compensation parameter.

17. The temperature control system of claim 10, wherein in a case that there are a plurality of the target device, the temperature of the target device is an average or a median of temperatures of the plurality of target devices.

18. The temperature control system of claim 10, wherein the target device comprises a memory storage device.
